(19) United States
(12) Patent Application Publication
(10) Pub. No.: US 2013/0020998 A1
(43) Pub. Date: Jan. 24, 2013

(54) Intelligent Battery With Off-Line Spare Battery Charging and Output Regulation System

(71) Applicant: Ryan Robert Howard, Seattle, WA (US)

(72) Inventor: Ryan Robert Howard, Seattle, WA (US)

(21) Appl. No.: 13/556,190

(22) Filed: Jul. 23, 2012

Related U.S. Application Data
(60) Provisional application No. 61/510,414, filed on Jul. 21, 2011.

(51) Int. Cl. H02J 7/00

(52) U.S. Cl. 320/117; 320/116

(57) ABSTRACT

A battery pack having multiple cells connected through “virtual” connections via MOSFETs, other insulated-gate field-effect transistors, and the like. The use of virtual connections allows for the use of one or more “spare” battery cells, which may be swapped in for underperforming cells or to take discharged cells offline for charging. A microprocessor monitors and manages individual battery cells or batteries in an array. The battery pack of the present disclosure may further include an optional cooling system and/or a novel encapsulation to protect the cells and electronics from use in harsh environments.

### CROSS-REFERENCE TO RELATED APPLICATIONS

This application claims priority under 35 USC §119 to U.S. Provisional Patent Ser. No. 61/510,414, filed on Jul. 21, 2011, and titled “Intelligent Battery with Off-line Spare Battery Charging and Output Regulation System,” the entire contents of which are hereby incorporated by reference.

### BACKGROUND

1. Technical Field

The present invention relates generally to batteries, and in particular to a versatile battery system for providing power for mobile and fixed uses in a variety of conditions.

2. Background

Typical prior art battery packs are multiple-celled, with the cells arranged in a hard-wired series configuration. The downside with this common cell configuration is that the cells may not be matched properly in voltage and current output, and over time lifespan between cells will differ. The “stronger cells” will become useless as they are dragged down by underperforming cells. Another disadvantage is that, in charging this type of battery, a typical means of charging is to provide a voltage level slightly above the pack float-voltage and to monitor current draw until charged. At times, the specific voltage needed to recharge the battery pack is not available.

Another downside with typical prior art battery packs is that if there is a catastrophic cell failure or even a low voltage or current condition of one of the cells in the battery, the entire battery pack becomes virtually useless.

What is needed, therefore, is a battery pack that comprises one or more spare cells, having the ability to selectively swap out cells as needed, and that provides for charging from variable input voltages.

### SUMMARY

Embodiments of the present disclosure include an intelligent battery system with a plurality of battery cells and a microprocessor. Each battery cell is connected to another battery cell by at least one TMOS junction. A TMOS junction comprises at least three insulated-gate field-effect transistors joined at the source node. The microprocessor is in communication with the at least one TMOS junction.

Additional embodiments include a method of maintaining a battery pack, comprising monitoring one or more conditions of a plurality of cells in the battery pack, identifying an underperforming cell, placing a spare cell into electrical communication with a battery terminal, and removing the underperforming cell from electrical communication with the battery terminal. The conditions are selected from the group consisting of voltage output, current output, output duration, recharge time, temperature, charge rate, voltage drop point, and current drop point.

Embodiments of the present disclosure further include a method of charging a cell in a battery pack, comprising monitoring one or more conditions of a plurality of cells in the battery pack, identifying a discharged cell, placing a spare cell into electrical communication with a battery terminal, removing the discharged cell from electrical communication with the battery terminal, recharging the discharged cell, thereby resulting in a charged cell, placing the charged cell into electrical communication with the battery terminal, and removing the spare cell from electrical communication with the battery terminal.

The present disclosure will now be described more fully with reference to the accompanying drawings, which are intended to be read in conjunction with both this summary, the detailed description, and any preferred or particular embodiments specifically discussed or otherwise disclosed. This disclosure may, however, be embodied in many different forms and should not be construed as limited to the embodiments set forth herein; rather, these embodiments are provided by way of illustration only so that this disclosure will be thorough, and fully convey the full scope of the invention to those skilled in the art.

### BRIEF DESCRIPTION OF THE DRAWINGS

FIG. 1 shows a non-series circuitry resulting from a the disclosed electronics design;

FIG. 2 is an example where a cell of the battery is taken off-line by the circuitry of the present disclosure;

FIG. 3 depicts an embodiment of the TMOS circuitry configuration;

FIG. 4 illustrates the circuitry of the present disclosure in combination with one example of a typical H-Bridge;

FIG. 5 illustrates three MOSFETs arranged in a triangular orientation, forming an embodiment of a TMOS component;

FIG. 6 illustrates an embodiment of a TMOS, reduced to a single integrated circuit component; and

FIG. 7 illustrates a temperature probe found in embodiments of the present disclosure.

### DETAILED DESCRIPTION

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention, and it is to be understood that modifications to the various disclosed embodiments may be made, and other embodiments may be utilized, without departing from the spirit and scope of the present invention. The following detailed description is, therefore, not to be taken in a limiting sense.

The present disclosure comprises an improved battery having multiple battery cells and a system of regulation therefor. FIG. 1 depicts an embodiment of the present disclosure having four cells in use and one cell being charged off-line, wherein the battery charging system of the present disclosure rotates and swaps out the cells—analogous to rotating in a car's spare tire. All five battery cells are cycled evenly, which allows 4V levels and below, like a small solar panel or USB power source. In contrast, many large batteries cannot be charged from a laptop or small USB 5V power source, while the battery system of the present disclosure may be so charged. Certain prior art batteries that are at 15.2V and above, e.g. the LI-145 battery manufactured by Ultralife Corporation, cannot charge directly off a standard 12V car system without a customer-specialized adapter. The battery system of the present disclosure can charge directly off a standard 12V car system without a specialized adapter since it has variable input charging. The battery of the present disclosure can charge off AC or DC and thus embodiments comprise a built-in collapsible wall outlet feature to allow the battery to be plugged into virtually any power source. One advantage of this configuration is that the embodiment of the present disclosure has no need of an external charger, which may typically be a bulky and expensive component.

Embodiments of the present disclosure may include USB ports by which the battery pack cells may be charged. Such embodiments further include a module to detect the USB version to match the highest charge rate possible for each USB version without overtaxing the power source. Alternative embodiments comprise multiple USB ports, each which have their own USB version detection module, so that different power sources having USB ports or even different USB ports on a single device may simultaneously charge the battery pack. A USB power source may act as a trickle charger or may provide a burst of power, depending on the USB version specifications.

Most batteries of the prior art are hard-wired in series, whereby one bad cell may render the entire battery useless. 20% of the cells of prior art batteries manufactured in the same batch do not match current and voltage outputs of the others. This variation in current and voltage output among cells inherently causes early battery failure. In the process of building a battery of the present disclosure, technicians may selectively match battery cells so that the cells have similar voltage and current output, which helps eliminate failures due to mismatched cells. In addition, if there is a catastrophic cell failure or even a low voltage or current condition of one of the cells in the battery of the present disclosure, the spare cell of the present invention may be substituted for the underperforming cell and to either increase the voltage or replace the cell entirely. The spare cell can increase the voltage by the circuit adding it to the end of the series, effectively adding another cell to the battery pack. The spare cell can replace the failed cell entirely electrically, not physically. The bad cell is taken out of the useable table by the circuit; the battery pack then no longer has a spare, but still may operate as a fully functioning battery pack.

The system disclosed herein may be analogous to a RAID (“redundant array of independent disks” or “redundant array of inexpensive disks”) system having multiple disks. In a typical RAID array, the controller monitors the health of each disk in the array, distributes data across the disks (thereby providing redundancy), increases performance by allowing parallel communication, and allows hot-swapping of disks. Similarly, the batter pack controller of the present disclosure monitors the health of each battery cell, provides a spare cell for power supply redundancy, increases voltage output by making series connections between cells, and allows hot-swapping of cells in the event of cell failure.

Embodiments of the present disclosure include an array of battery packs, where an array's constituent battery packs are tied together in communication as an active system. For example, one or more battery packs may be designated to be spare/redundant battery packs and only activate when needed. As an additional example, one battery pack in the array may activate only a few of its cells to provide power to another battery pack in the array. In embodiments, the battery packs in an array may communicate over powerline. Alternate embodiments comprise dedicated communication lines such as over USB and the like. Other alternate embodiments comprise wireless and/or Zigbee communication modules.

In embodiments of the present disclosure, the system implements “tail tracking,” whereby if certain cells or battery packs have a “drop-off” in voltage, current, or power at a certain level, the system will remove that cell or battery pack for recharging, or will replace that cell or battery pack with one that exhibits better performance. The system may track the tail drop over time for any cell or batter pack and remove that cell or pack if needed.

The battery configuration of the present disclosure is not “series limited” since it is controlled with a battery-charging system design. Thus the battery of the present disclosure is not limited by internal connections as are prior art batteries. The system bypasses the underperforming or “bad” cell. The battery charging system circuitry of the present disclosure allows a “virtual series cell chain” which is a non-hard-wired connection between battery cells, electrically in series, accomplished by the use of MOSFET or other insulated-gate field-effect transistor switches. The virtual series cell chain of the present disclosure provides the ability to dynamically rotate cells digitally within a typically hardwired chain; with no drop in output to the load. This battery circuit allows for true offline charging on an individual cell basis, thereby eliminating the inherent problems charging a cell with an active load on it. This is accomplished using a microprocessor coupled to a unique electronic component called a TMOS.

It is well-known that batteries heat when being recharged and/or discharged. This excess heat may destroy the chemistry of a battery and reduce its useful life and number of charge cycles. Embodiments of the present disclosure include internal and/or external solid state cooling provisions. This cooling provision extends the useful life of the battery. Embodiments of the present disclosure comprise one or more modules that actively monitor temperature of each cell during charging/discharging or during other phases.

Most batteries of the prior art are packaged and glued within plastic, and are not necessarily impervious to water, solvent, acids, dust, or other harsh environmental variables. Embodiments of the present disclosure comprise a battery completely sealed with a military specification-grade epoxy that is resistant to water, solvent, acids, and which is also thermally conductive. Embodiments comprise an encapsulant that is fireproof to UL 94-V0 Burn Test, and is explosion proof. For disposal, the battery encapsulation epoxy may prevent any chemistry of the battery to leak into water, which makes the battery much safer for disposal and positions the battery to meet stringent EPA regulations.

The battery of the present disclosure comprises a resettable thermal fuse with on average over 100,000 resets. Additionally, embodiments include a watchdog timer which monitors the number of resets due to short circuits in a certain period of time via microprocessor. The watchdog timer throws an alarm for the user to press a membrane switch to reactivate the battery. These variables are programmable, and the unit will shut down on thermal events such as over temperature.

Embodiments of the present disclosure comprise an on-board external programmable microprocessor having computer-readable instructions adapted to provide the following functions: device-type identification; monitoring of the aggressiveness of charge/discharge of the battery; watchdog and fuse reset times; voltage output and input to optimize battery chemistries, including LiPO, LiFePO4, standard lithium-based batteries; Pb-acid (lead acid), NiMH (nickel metal hydride), or NiCd (nickel cadmium); and optimization/management of spare battery cell, including rotation of the spare battery cell for charging and discharging to evenly distribute cell life.

One of ordinary skill in the art having the benefit of this disclosure would understand that numerous alternative embodiments of the concepts disclosed herein are possible. Embodiments of the present disclosure comprise a module to accept an input to charge over USB. Embodiments of the present disclosure comprise of super capacitors (“supercaps”) integrated into circuitry to optimize battery life as described below. Alternative embodiments include internal or external cooling features, such as a Peltier device cooling module.

The “virtual” connection circuitry resulting from the disclosed design is shown in FIG. 1. In the embodiment disclosed, cells are each 3.2 volts. Five cells are shown, though the battery of the present disclosure may have any number of cells. Shown in FIG. 1 is a spare cell. The diagram of FIG. 1 shows how a battery of the present disclosure has individual cells that can be pulled out of series via the TMOS 100 components of the invention disclosed herein. By electrically enabling legs going to the cells via the TMOS that is controlled by the microprocessor, the battery of the invention can take a cell in and out of series. On the diagram is shown the MP, which is the microprocessor input and goes to all TMOS circuits. Also disclosed herein is the TMOS circuit.

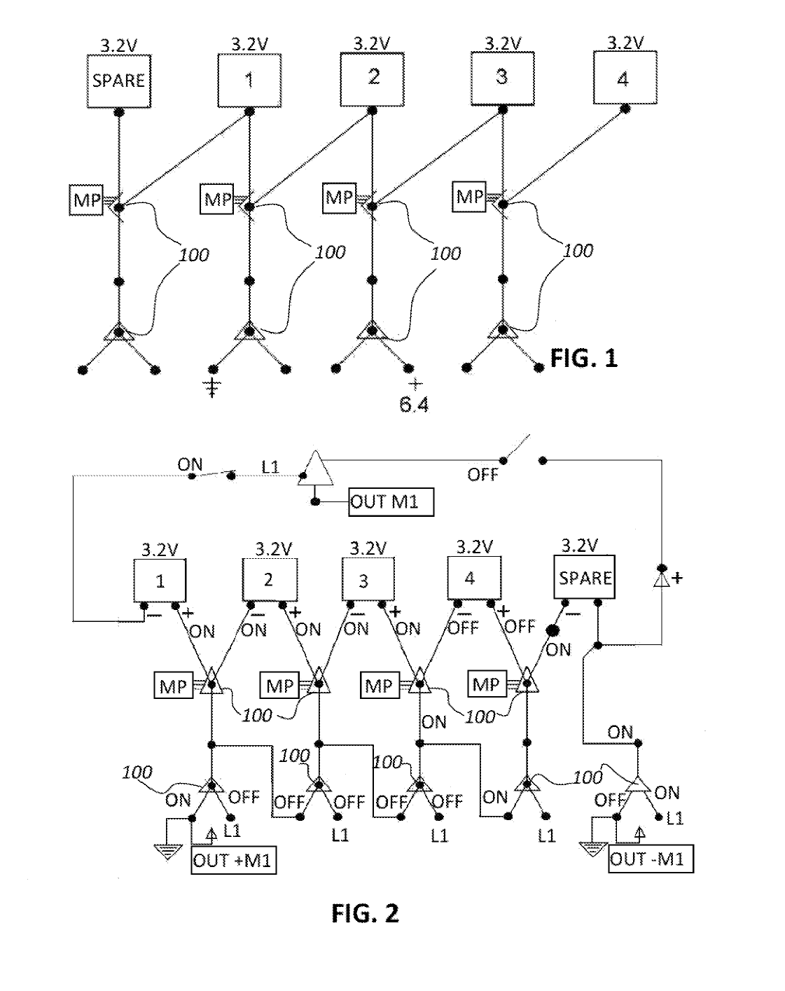

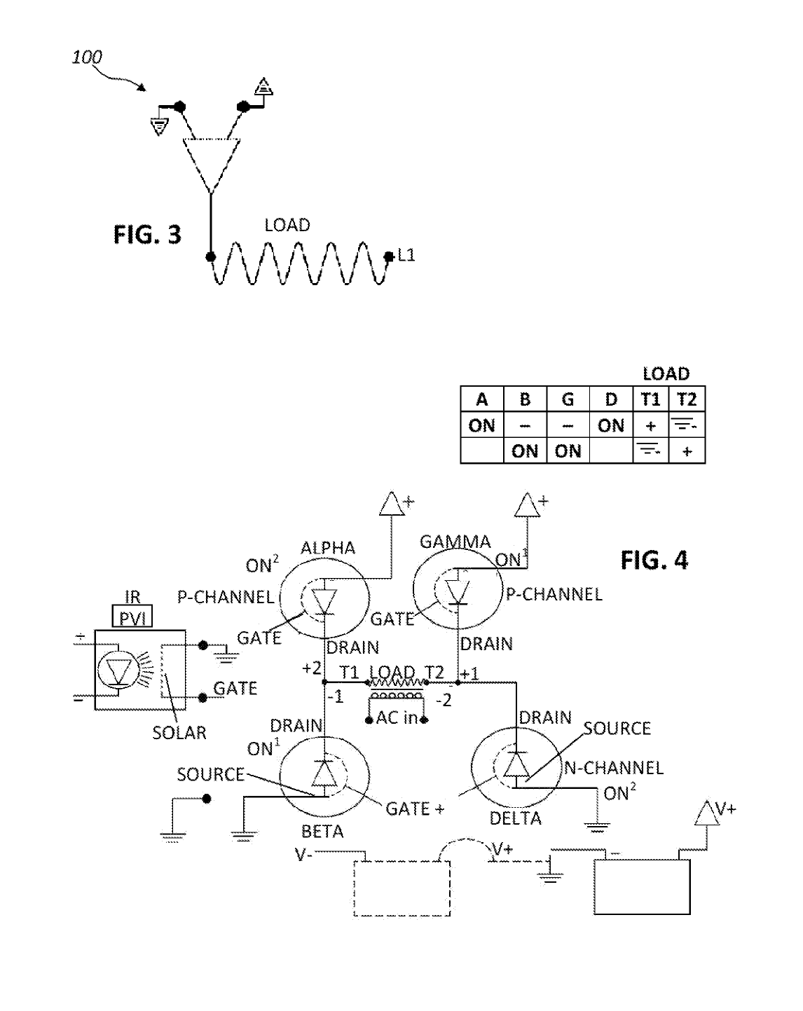

FIG. 2 depicts an example where cell labeled #4 is taken off-line by the circuitry of the present disclosure. This circuitry, which will be understood by one of ordinary skill in the art having the benefit of this disclosure, is configured such that through the MOSFET arrangement into the TMOS 100 configuration, triangulated, and the positive and negative side of the battery cells are wired such that they are actually in series, by way of the microprocessor programming the MOSFETs to have their gates enabled or disabled. In short, the MOSFETs allow the flow of electrons to follow a path to make any combination of cells in series, or to leave out one of the cells, i.e. to make it offline, for separate charging. FIG. 3 depicts a TMOS 100 of the present disclosure. The novel circuitry of the present disclosure is a tertiary switching system; a new type of triangular based switching system more advanced than prior art H-bridge configurations.

FIG. 4 depicts one example of an H-Bridge, further comprising a photovoltaic isolator (“PVI”) to optically serve as a switch to drive the corresponding MOSFETs in the H-5 bridge and in the battery circuitry.

The non-series circuitry of the invention may also be termed “virtual variable selectable series circuitry.” Rather than a hardwire going form cell to cell to cell (positive to negative to positive to negative, etc. in series), which is currently utilized in typical devices of the prior art, the system disclosed utilizes a novel MOSFET (or other or other insulated-gate field-effect transistor) and isolated driver circuit coupled to a microprocessor arrangement. The microprocessor reads voltage, current, and other operating characteristics of each cell, as well as the overall output of the system.

The “spare cell” of the present disclosure is explained with reference to the block diagram of FIG. 1. The spare cell is a real physical cell. Typical prior art designs have all battery cells hard-wired in series. The system of the present disclosure arranges cells numbered 1, 2, 4, 5, 6, and 7 in series, for example using cell 3 as a spare. This arrangement is changed as the circuitry senses the need to be changed, for example if there is a catastrophic cell failure or even a low voltage or current condition of one of the other cells in the battery. For example, cell 3 could be coupled in series with the other cells, and cell 5 would be taken offline permanently, or temporarily for charging/conditioning.

The step up/down converter and advanced power regulation system of the present disclosure allows longer use between charges, and is explained as follows: Embodiments of the present disclosure may comprise commercial off-the-shelf (“COTS”) components such as transformers to step up or step down input voltages to that allows for switching of ultralow voltages, which in the past has been a problem with the forward voltage drop of a typical diode, which is 0.6 to 1.2 volts. The reason for longer use between charges in the present disclosure is that the present disclosure can take advantage of low voltage sources, such as body heat which puts out 60 mV, and boost this voltage up to a useable 3.3 to 3.6 volt level that is adequate to charge a single cell of the battery. Typical prior art battery packs which are hardwired in series typically need the collective voltage of the number of cells multiplied by their individual voltage, e.g. 5 cells at 3.2 volts which equals 16 volts. Therefore a 16+ volt charge source is needed to recharge a hardwired series battery and, lower voltage sources are not usable for recharging. In contrast to the prior art, embodiments of the present disclosure can charge cells of the battery offline, that is, there is no load on the cell while it is charging. This ability to take the cell offline and charge it while there is no load applied is beneficial because the charge circuit can test the particular cell with its own known load value (control group) to determine how to charge the battery and what its state is at. If an external load is applied as well as external voltages and currents from hardwired batteries, as in the prior art, a true test cannot be made. Conversely, if the cell is offline and has no load, an accurate test can be made.

The supercap design provides more max pulse discharge in a proprietary electronics design. Supercaps have a long cycle life, even to 1.5 million cycles. Batteries may only have a cycle life of 100 to 3000 cycles. The supercap may act as a transient voltage suppressor and thereby protect the battery cells. Because the supercaps “take the hit” of voltage spikes, as explained herein, the cycle life of the battery is extended. Supercaps also have the ability to put out a high level of current for a short duration of time which is typically seen with high inductive loads (like a cell phone or radio in transmission mode).

Embodiments of the present disclosure have a rectifier system which is similar to an H-bridge drive system which is typically used for reversible current voltage flow into a load source, i.e. a DC motor. An H-bridge can function as a rectifier such as a full bridge rectifier due to the inherent body diode of the P and N-channel MOSFETs. When actively switched via the microprocessor, embodiments of the present disclosure may achieve a higher efficiency and lower resistance than prior art circuits which results in the ability to rectify lower voltages than the inherent body diodes. Therefore, in contrast to the prior art, the present disclosure may passively or actively rectify a voltage source over a wide range of voltage inputs.

Frequency of the charging voltage does not matter, and can be varied within the voltage range is provided by the present disclosure. For example, if a circuit has “wild” AC (i.e., from a wind turbine), which will have a variable frequency out based on the wind speed and resulting RPM of the rotor/generator, most chargers have a limited frequency range, such as conventional 50-60 HZ for US or European power grids. In contrast, embodiments of the present disclosure do not have such a limitation, due to their high-frequency microprocessor controlled H-bridge. For example, embodiments comprise MOSFETs having the capability to switch every 20 nanoseconds (0.5 GHz). Depending upon the application, microprocessors or sub components can be selected that work in conjunction with the microprocessor to achieve higher switching rates.

Ultra-high amperage burst rate capability is provided by the supercap configuration which is in-line with the load and the battery and is in-line with the charging system and the battery. As a result, the invention can take large inrushes of current. The present invention utilizes two Supercaps, one is fully charged and one is fully depleted. The fully charged supercap is in-line with the battery and the load such that the supercap is depleted before the battery which has enough hold-up duration for most short inductive load spikes, hence the battery does not see a damaging spike which would affect its cycle life. Alternatively, inbound, while charging, such as by “wild” AC, or even on the conventional grid, voltage and current spikes are frequent. The supercap in-line prior to the battery on the charging side, which is depleted, can absorb these large inrushes of current/voltage and prevent damage to the battery while still capturing the energy safely. The present invention can shunt excess voltage levels beyond a single supercap to both Supercaps if they are both discharged as well as to an internal load, such as a Peltier device. In the case of highly inductive loads which will generate voltage spikes back from the load when turned off, such as a radio, this arrangement is very useful because with the H-bridge of the invention there is a recycling of unused power that is normally dissipated as heat; the present invention can utilize the unused power (the load inductive spike power) for regenerative charging. Regenerative charging at the battery level is novel. Radios have a very inefficient conversion of electrical power to RF waveforms, which may be 1:100; the majority of the power is lost to heat, whereas the system of the present invention rerouts this RF inductive field collapse pulse into the front-end charging system thus recycling the energy and avoiding the dissipation into heat which is unusable and for military applications can enhance your thermal signature for targeting. A hot radio attracts a drone, which is unwelcome in battlefield conditions.

As disclosed herein and demonstrated in diagrams, the design of the battery solutions of the present disclosure has taken a revolutionary approach to not only interconnecting cells within a virtual series connection, but also individually monitoring cell health performance voltage and current levels, as well as individual cell temperatures. The battery cells are charged individually without the burden of potential load on the system by utilizing an off-line cell taken out of the virtual series chain. The method of charging this off-line cell also differs because of using highly regulated variable voltage which is pulse width modulated (PWM). This method of charging allows the cells to increase their charge levels rapidly but given the PW restoration, it allows time for the chemistry in the battery to cool which extends its life, cycle and overall, and allows for a much faster recharge rate.

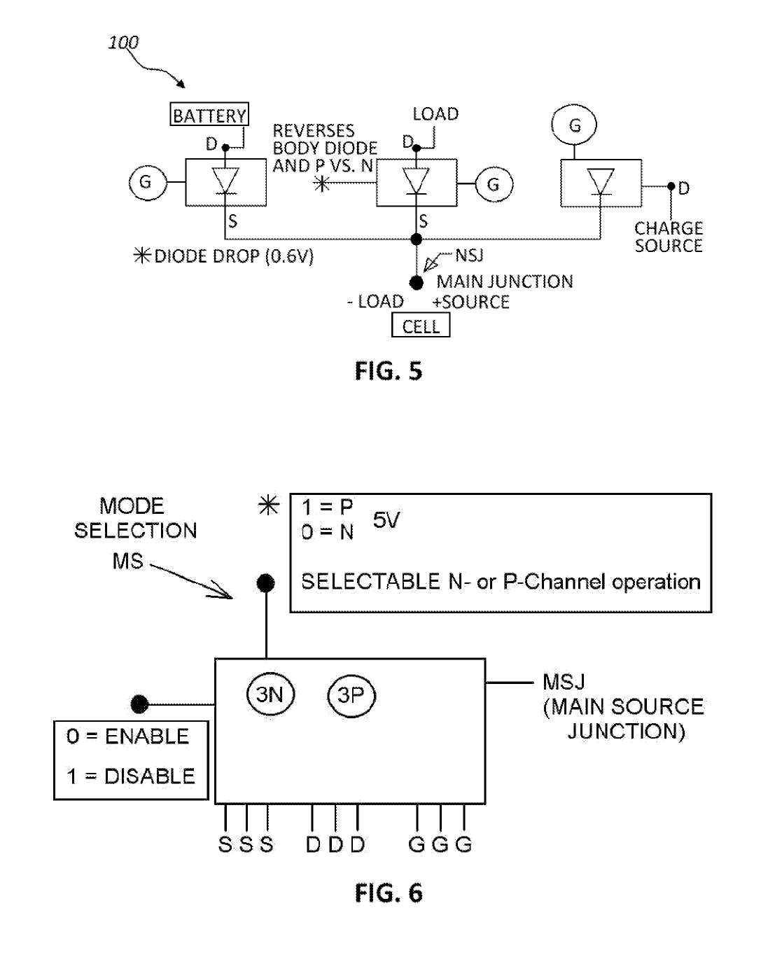

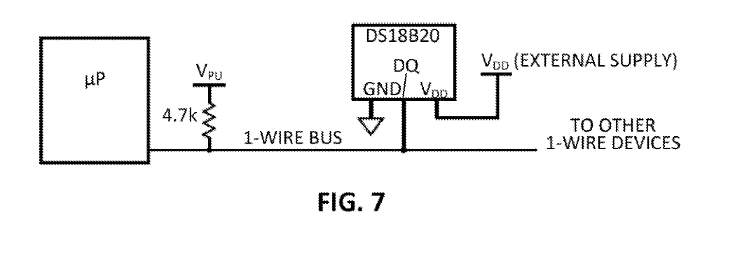

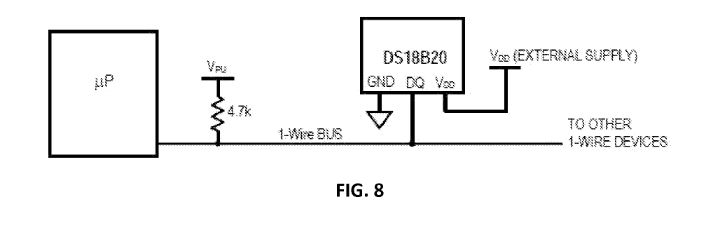

With reference to FIG. 5, charging circuitry is on-board microprocessor controlled with multi-chemistry charging ability as disclosed herein. Triangular Metal Oxide Semiconductor (“TMOS”) and is a triangular MOSFET (or other insulated-gate field-effect transistors). The TMOS 100 of the present disclosure is similar to a 3-way switch. FIG. 5 shows three MOSFETs arranged in a triangular orientation, forming the TMOS device of the present disclosure. In alternate embodiments, a TMOS may comprise analog relays, solid state relays, or other known switching components.

FIG. 6 depicts the TMOS above reduced to a single integrated circuit component. This shows a 12 pin package. One pin is for enabling/disabling the TMOS. With no signal it is enabled by default. With a signal it is disabled. The microprocessor can turn the whole set off. One pin is for MS, which means “mode select.” Most MOSFETs are either n- or p-channel. The device of the present disclosure has six MOSFETs: 3 n-channels, 3 p-channels.

Prior art batteries could not be effectively cooled because of being encapsulated in plastic which is a thermal insulator. In contrast, the battery of the present disclosure is encapsulated in thermally conductive, but not electrically conductive, epoxy. Alternate embodiments of the present disclosure comprise a Peltier device, as disclosed herein. This device is made using a mold with various shapes and designs. Due to the unique epoxy encapsulation the battery, embodiments are submersible and the battery may be protected from dust and other chemicals by the unique epoxy encapsulation. SCUBA divers may use the battery underwater. The Mil-Spec grade epoxy encapsulant utilized in the batteries of the present disclosure is resistant to water, solvent, acids, and is also thermally conductive. The Mil-Spec grade epoxy may be an epoxy that is currently manufactured by MG Chemical. The epoxy encapsulant fills in and protects components from resonants which can harm internal components.

Digitally selectable voltage output accomplished by certain embodiments of the prior art by the microprocessor having a routine programmed on it that is controlled by external membrane buttons tied to an LCD display that, when pressed displays the active voltage that the main terminal will put out and a secondary button is pressed to confirm that voltage, which the LCD is blinking, is what the user wants. The user continues to press the button until the reading is the desired for output voltage. Once the correct voltage is displayed, another button is pressed, which locks in the voltage and the blinking of the LCD stops. The LCD outputs stays active, for example, for 30 seconds or another desired period since this feature is programmable, then the LCD outputs shuts off. User checks status by repeating the foregoing routine. Embodiments of the present disclosure include dual-ended supply out terminals, for example to provide plus or minus 12V output.

Embodiments of the present disclosure are adapted to operate over a wide range of operating voltages in comparison to prior art batteries which gives it the ability to power a broader range of devices. The battery of the present disclosure also has a digitally selectable voltage output which differs from most prior art batteries which have a fixed voltage output. Embodiments comprise one input and two outputs: USB input at 5V, one output is USB compliant at 5V, and the primary output which, as stated herein, is digitally selectable and is designed to drive a primary device, such as a radio.

Embodiments of the present disclosure may provide 15.2V in raw mode, or pass through mode. Embodiments comprise a step-up and step-down converter that allows for outputting a specific voltage, regardless of the charge state of the cells, within reasonable limits. The battery system comprises a combination of the step-up/down converter, and the spare cell, allowing longer use between charges, like a spare tank mode or emergency mode. Example: the prior art LI-145 reduces to 11V, thus it cannot power a 12.8V device. The LiPO of the invention, however, since it has the fifth cell as “spare gas tank” and can switch over to using that when the other four cells in series reduce to 11V, and with the higher voltage spare now in service, in combination with the proprietary advanced power regulation system of the invention, gives a new voltage of 12V, thus extending the useful of the battery before having to recharge it.

Embodiments of the present disclosure have a true nominal capacity, meaning that they can drain at a higher voltage and a higher current rating than prior art batteries. A LiPO battery can drain at 100 A, without harming the battery chemistry, which is 20 times the drain rate of the prior art LI-145 battery. Compared to the rating of the LI-145 at 9.4 Ah divided by 5 C would equal 1.88 A per hour max drain multiplied by an average voltage of 15.2 V to yield 28.58 W/h for 5 hours. The battery of the present disclosure is rated at 12.5 Ah divided by 5 C netting 2.5 A per hour nominal, safe, drain to not hurt the number of cycles multiplied by 21 V to yield 52.5 W/h for 5 hours for a total of 262.5 Wh. Thus, the LiPO battery found in embodiments of the present disclosure is roughly 9 times better than the prior art LI-145 battery in terms of capacity. Note that when considering the value for a LiFePO4 battery used in the present disclosure using the same equation is 393.8 Wh; similar calculations as per the LiPO. Relative to the prior art battery, the LiFePO4 battery of the invention is more than 13.5 times better than the prior art LI-145 battery.

The prior art LI-145 battery system can put out 5 A max discharge continuous. The battery of the present disclosure may output 100 A continuous without hurting the battery. The battery disclosed herein could potentially power a radio to go 20 miles, while the prior art LI-145 battery can only power the same system for 1 mile.

If a relatively high power output is required for 30 seconds, the battery of the present disclosure could provide it, while the prior art LI-145 battery cannot. The prior art battery can output at 5 A*15.2V=76 W for 30 seconds. In contrast, the battery of the present disclosure can accomplish this task using the LiPO battery at 150 A*21V=3,150 W for 30 seconds—an improvement of over 40 times. This means the battery of the present disclosure can run a 4.22 hp motor for 30 seconds, while the prior art LI-145 battery technology can run a 75 W light bulb for 30 seconds or a 0.1 HP motor for 30 seconds. Other embodiments of the present disclosure further include super capacitors (“supercaps”), which may positively affect the Maximum Pulse Discharge, as described below. The LiFePO4 chemistry-based battery of the invention is 281.25 A*21V=5,906 W for 30 seconds (which translates into operating a 7.92 HP motor), which is an improvement of over 75 times.

Embodiments of the present disclosure have an energy density of roughly 262.5 Wh/kg. In contrast, the existing prior art Li 145 battery has an energy density of 140 Wh/kg. The batteries of the present disclosure have an 85% energy density improvement over the prior art LI-145 battery.

The battery disclosed herein has an additional cell as a spare cell, which adds 25% to the typical LiPO number of 300 cycles, and the supercaps help the surge currents and an expected nominal 25% improvement due to the supercap integration. The result is 450 cycles for the battery of the invention. The LiFePO4 battery of the invention has 2,000 cycles, increasing to 3,000 cycles with the extra cell as a spare and supercap integration.

The battery of the present disclosure has a greater temperature operation range than prior art batteries. This increased temperature operation range can contribute to extended battery life and more storage options.

LiPO battery of the present disclosure has 1, 3, or 6 month ratings. The closer the storage temperature to the median of the battery's temperature range, the longer the allowable storage period. Temperature extremes reduce battery life. Embodiments of the present disclosure include a Peltier device onboard. If the battery encounters extreme temperatures, either hot or cold, the battery can self-regulate its temperature. The device can be programmed to be maintained just above freezing, as an example.

The chemistry of the batteries of the present disclosure allows charging improvement of the LiPO over the prior art LI-145 battery. Thus the time-to-charge is reduced considerably over prior art batteries. The battery of the present disclosure can be charged in one hour, while existing prior art batteries on the market take over two hours at maximum charge rate which damages the battery.

The LI-145 battery of the prior art has a published specification of 300 cycles, and a reported life of one to two years. Three main factors affect battery life. One factor is the chemistry shelf life. As any battery sits it approaches chemical neutrality over time due to heat, environmental factors, etc. Another prime factor affecting battery life is charging and discharging. The rate at which a battery is charged or discharged affects the number of cycles a battery. The third factor affecting battery life is how many cycles the battery has, coupled with the amount of discharge any cycle undergoes. A partial discharge and recharge of the LI-145 battery counts as one of the 300 cycles and reduce the battery's life accordingly. The battery of the present disclosure can be discharged to 100%. Further, due to the chemistry of the LiPO battery of the invention, a partial discharge is just that, a partial discharge if recharged, then the battery only requires a partial cycle, not a full cycle, thus life is prolonged. Also, due to the proprietary electronics design of the present disclosure using supercaps, the super capacitor itself receives the brunt of any large inductive pulses, such as those that occurring in radio transmission. A supercap can take 1.5 million of these “hits,” thus sparing the battery itself of this instantaneous current draw, which prevents the battery from losing a significant percentage of its current charge level. The battery of the present disclosure may support at a minimum 450 full cycles, with the LiFePO4 battery supporting over 3,000 cycles.

It is expected that the life of the LiPO battery of the present disclosure, with the supporting electronics design, the supercaps, and the improved chemistry, will last at least three to four years. The life of the LiFePO4 battery of the present disclosure is expected to be four to five years, and the battery is vastly more useable than prior art batteries during this timeframe.

The time-to-charge for the batteries of the present disclosure is reduced considerably over prior art batteries. The battery of the present disclosure can charge in one hour: the charge rate of the LiPO battery is equivalent to Ah capacity (1C) rating; 12.5 A, and 12.5 A thus takes one hour. In contrast, the prior art battery takes over two hours at the maximum charge rate (which also may damage the battery). The charge calculation for the LI-145 battery of the prior art is 5 A to a maximum voltage of 16.8V, and the LI-145 battery of the prior art has a 9.4 Ah cell, so it takes almost 2 hours to charge the prior art battery, but such strenuous charging stresses the battery and reduces the total discharge/charge cycles of the LI-145 battery. The reasonable charge rate of the LI-145 battery thus may be 1.88 A/2=0.94 A. Thus for safety purposes, and to preserve the number of charge cycles, it could typically take 10 hours to charge the LI-145 battery.

The prior art LI-145 battery is rated at 5 A*15.2V=76 W. The LiPO battery of the present disclosure is rated at 100 A*21V=2100 W, which is roughly 27 times the output of the prior art LI-145 battery. The LiFePO4 of the present disclosure is rated at 187.5 A*21V=3,938 W, which is roughly 50 times the output of the prior art LI-145 battery.

The LI-145 battery of the prior art is reported to be 12 h, with an energy capacity of 143 Wh; which would be an average of 143 Wh/12 h=11.92 W consumption in one hour. The LiPO battery of the invention is 262.5 Wh energy capacity. Since the LiPO battery has the spare cell, that adds another 25%, or, 262.5 Wh*1.25=328.1 Wh. Using the same 11.92 W consumption in one hour, the LiPO battery actual use time is 328.1 Wh/11.92 Wh per hour equals 27.5 hours. With the electronic configuration of the invention, including the use of the proprietary supercaps, this 27.5 h number could be expected to actually be closer to 40 h.

The LI-145 battery of the prior art must typically be replaced every 1 to 2 years. The LI-145 battery of the prior art requires external charger(s) which adds additional cost, and requires more batteries per mission. The LiPO of the present disclosure may be replaced every 3 to 4 years. Embodiments of the present disclosure comprise a charger system on board. The charger system includes a USB input to charge from laptop or cellular/car charger. Alternate embodiments comprise a DC wide range or AC fold-down receptacle plug.

Cost advantages of the system presently disclosed may result, in part, from the reduced frequencies in replacing batteries on-board charger system. Another potential cost advantage is the encapsulated batteries of the present disclosure may be safely disposable; NOAA and other Federal Agencies are being charged disposal fees that can significantly increase the cost of the battery when disposal fees are included. Yet another potential cost advantage is an improvement in the pure logistics of storing, handling, replacing, and field issues of batteries of the present disclosure to the soldier or to the remote sensing stations supported by these batteries.

Typical prior art battery packs are multiple-celled, with the cells arranged in a hard-wired series configuration. The downside with this cell configuration is that the cells may not be matched properly in voltage and current output, and over time lifespan between cells will differ. The “stronger cells” will become useless as they are dragged down by underperforming cells. Another disadvantage is that, in charging this type of battery, a typical means of charging is to provide a voltage level slightly above the pack float-voltage and to monitor current draw until charged. No consideration is taken for each individual cell, nor consideration for secondary items such as cell temperature. More advanced prior art charging systems on the market tie into traditional cells in a hardwired series configuration, but tap each series point and charge the particular cell from a ground reference point. This prior art charging system may also have some rudimentary pack temperature monitoring for over temp control, but this is a very basic make-or- break circuit based on a threshold temperature. Another significant deficiency to most prior art charging systems is that they are charging the cells under a load. Prior art charging systems may also be affected by adjacent cell voltage due to the hardwiring method prevalent on the market today.

In the design of the LiPO and LiFePO4 battery solutions of the present disclosure, not only are interconnecting cells connected within a virtual series connection, but also the system disclosed monitors individual cell health performance, voltage, current levels, and temperatures. The battery cells of the LiPO and LiFePO4 battery solutions of the present disclosure are charged individually without the burden of potential load on the system by utilizing an off-line cell taken out of the virtual series chain. A method of charging an off-line cell may be highly regulated variable voltage via pulse width modulation (PWM). This method of charging allows the cells to increase their charge levels rapidly but given the PW restoration, it allows time for the chemistry in the battery to cool, which may extend its life cycle and provide for a faster recharge rate.

The battery solutions of the present disclosure include a spare cell, as previously described, which is utilized as an off-line charging cell that is rotated in much like a spare time on a car. Thus, like the car, the innovative design extends the life of the complete battery because of the management of the rotating spare cell, whereby one cell is always “resting” and is available for full use when required as additional voltage is required, like a spare tank. The charging circuitry of the invention manages this cell rotation, as well its charging, and the overall charging of the battery pack. When the health of a particular cell becomes unusable in the system, the spare cell becomes a full-time cell instead of the entire battery pack immediately becoming virtually useless. The battery pack of the invention may be uniquely encapsulated in thermally conductive but environmentally safe and waterproof epoxy which protects the cells physically from the elements and makes it submersible, suitable for use in underwater applications. Since the epoxy can be thermally conductive, the battery can be placed in an externally cooled environment such as a rapid charger with a cooling plate. This thermally cooled charging scenario allows for preservation of the battery chemistry temperature, while receiving a very high charge rate without damaging the battery cells.

The charging circuitry may be controlled by an on-board microprocessor controlled with multi-chemistry charging ability, i.e. LiPO, Lithium, LiFePO4, lead acid, NiCd, NiMH, etc. The same cell-by-cell approach, along with a spare cell, can be applied to larger configurations such as battery arrays, telecom, UPS (Uninterruptable Power Supply), and military applications.

In certain embodiments, components used in the charging circuitry include: a microprocessor, MOSFETs, IGBTs, Supercaps, individual cell temperature sensors, I²C current and voltage sensing circuits. The charging circuit also includes multiple TMOS components, which comprises multiple MOSFETs (or other insulated-gate field-effect transistors) connected at the respective source nodes of each transistor.

In embodiments of the present disclosure, the battery pack may accept a wide-range of voltage input, AC or DC, which allows for charging of the battery via its standard connector or a unique two-pin foldout AC receptacle. The frequency of the charging voltage may be varied within the voltage range from 3.2V to 600V. The charging circuit also comprises both an inbound and outbound USB port to run or charge USB-based devices on the outbound port; the inbound port can be plugged into any standard USB receptacle and will charge the battery subsystems off that source. The USB outbound port is independent of the battery's main outbound connector, which is a digitally selectable voltage output.

The supercaps, or super capacitors, are on the input and output sides of the battery so that large instantaneous charging spikes, or heavy outbound current loads are mitigated by the ability of the super capacitor to put out large amounts of power momentarily for an average of 1.5 million cycles, compared to an average cell which varies from 100 to 3000 cycles (depending on battery chemistry).

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

1. An intelligent battery system comprising:
a plurality of battery cells, wherein each battery cell is connected to another battery cell by at least one TMOS junction, and wherein each TMOS junction comprises at least three insulated-gate field-effect transistors joined at a respective source node of each insulated-gate field-effect transistor; and
a microprocessor in electrical communication with the at least one TMOS junction.

2. The intelligent battery system of claim 1, further comprising a USB version detection module.

3. The intelligent battery system of claim 1, further comprising an array of battery packs, wherein:
each battery pack comprises a plurality of battery cells and
a first battery pack is in electrical communication with a second battery pack, wherein the first and second battery packs are within the array of battery packs.

4. A method of maintaining a battery pack, comprising:
monitoring one or more conditions of a plurality of cells in the battery pack, the one or more conditions selected from the group consisting of voltage output, current output, output duration, recharge time, temperature, charge rate, voltage drop point, and current drop point;
identifying an underperforming cell;
placing a spare cell into electrical communication with a battery terminal; and
removing the underperforming cell from electrical communication with the battery terminal.

5. The method of claim 4, wherein the underperforming cell comprises a discharged cell, the method further, comprising:
recharging the discharged cell, thereby resulting in a charged cell;
placing the charged cell into electrical communication with the battery terminal; and
removing the spare cell from electrical communication with the battery terminal.

6. The intelligent battery system of claim 1, further comprising a temperature sensor adapted to measure a temperature of a selected battery cell and transmit said temperature to the microprocessor.

7. The intelligent battery system of claim 1, wherein the at least one TMOS junction is adapted to selectively remove a battery cell from electrical communication with a battery terminal.

8. The intelligent battery system of claim 1, wherein the plurality of battery cells and the at least one TMOS junction are encapsulated in an encapsulant.

9. The intelligent battery system of claim 8, wherein the encapsulant comprises an epoxy.

10. The intelligent battery system of claim 1, wherein the plurality of battery cells comprises a spare battery cell.

11. The intelligent battery system of claim 1, further comprising a Peltier device.

12. The intelligent battery system of claim 11, wherein the Peltier device, the plurality of battery cells, and the at least one TMOS junction are encapsulated in an encapsulant.

13. The intelligent battery system of claim 1, wherein the at least one TMOS junction is adapted to electrically place at least some of the plurality of battery cells in series.

14. The intelligent battery system of claim 1, wherein the at least one TMOS junction is adapted to electrically place at least some of the plurality of battery cells in parallel.

15. The method of claim 4, wherein:
placing the spare cell into electrical communication with the battery terminal and
removing the underperforming cell from electrical communication with the battery terminal
are performed by at least one TMOS junction; wherein the at least one TMOS junction comprises at least three insulated-gate field-effect transistors joined at a respective source node of each insulated-gate field-effect transistor.

16. The method of claim 4, further comprising selectively applying heat to the battery pack in response to a temperature below a preselected threshold.

17. The method of claim 4, further comprising selectively cooling the battery pack in response to a temperature above a preselected threshold.

18. The method of claim 5, wherein:
placing the charged cell into electrical communication with the battery terminal and
removing the spare cell from electrical communication with the battery terminal
are performed by at least one TMOS junction; wherein the at least one TMOS junction comprises at least three insulated-gate field-effect transistors joined at a respective source node of each insulated-gate field-effect transistor.

19. The method of claim 5, wherein recharging the discharged cell comprises regulating a recharge voltage via pulse width modulation.

20. A method of providing electrical power, comprising:
electrically placing a plurality of battery cells in parallel via at least one TMOS junction; wherein the at least one TMOS junction comprises at least three insulated-gate field-effect transistors joined at a respective source node of each insulated-gate field-effect transistor; and
in response to a changed power need, electrically placing the plurality of battery cells in series via the at least one TMOS junction.
